(19) United States
(12) Patent Application Publication
(10) Pub. No.: US 2024/0007940 A1
(43) Pub. Date: Jan. 4, 2024

(54) CELLULAR COMMUNICATION DEVICE, SECURITY MODULE AND ELECTRONIC DATA STRUCTURE FOR PLMN

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventor: Antonius Norp, The Hague (NL)

(21) Appl. No.: 18/268,129

(22) PCT Filed: Dec. 16, 2021
(86) PCT No.: PCT/EP2021/086158

§ 371 Date: Jun. 16, 2023

(30) Foreign Application Priority Data
Dec. 22, 2020 (EP) 20216564.3

(51) Int. Cl. H04W 48/18; H04W 60/04; H04W 48/10; H04W 8/22

(52) U.S. Cl. CPC H04W 48/18; H04W 60/04; H04W 48/10; H04W 8/22; H04W 84/042

(57) ABSTRACT

One aspect of this disclosure pertains to a cellular communication device configured for performing a Public Land Mobile Network, PLMN, selection procedure to attempt registration with a PLMN. The selection procedure involves accessing a PLMN selector list, the PLMN selector list comprising at least one pair of a PLMN entry and at least one Radio Access Technology, RAT, entry, each RAT entry indicating one RAT. The PLMN entry of the (PLMN; RAT) pair is associated with a value set to indicate that two or more PLMNs may be selected. The cellular communication device is configured to sequentially select the two or more PLMNs when processing the (PLMN; RAT) pair in the PLMN selector list to attempt registration with the selected PLMN.

### TECHNICAL FIELD

The present disclosure relates to a cellular communication device, a security module and an electronic data structure for selection of a Public Land Mobile Network, PLMN. In particular, the disclosure relates to a cellular communication device configured for performing a PLMN selection procedure to attempt registration with a PLMN by accessing a PLMN selector list comprising a PLMN entry and at least one radio access technology, RAT, entry.

### BACKGROUND

Cellular communication devices are configured to connect to a plurality of Public Land Mobile Networks (PLMNs). The term PLMN selection defines a procedure in the cellular communication device (e.g. a UE as standardized by 3GPP), wherein candidate PLMNs are chosen and registration is attempted with one of the PLMNs. If the attempt fails, another PLMN may be selected for a registration attempt. The PLMNs to be selected may be organized by preference of a user and/or an operator.

The cellular communication device contains a security module, e.g. a (U)SIM or eSIM, that may have at least one of a User Controlled PLMN selector list and an Operator Controlled PLMN selector list. The User Controlled PLMN selector list allows the user of the cellular communication device to indicate a preference for network selection. The Operator Controlled PLMN selector list is provided by the operator of the home PLMN of the user (i.e. the operator to which the user has a subscription). Both PLMN selector lists may contain a list of preferred PLMNs in priority order. PLMNs are indicated by PLMN entries in the PLMN selector list. The PLMN selector list may have radio access technology, RAT entries, associated with PLMN entries to constitute a (PLMN; RAT) pair. As an example, a (PLMN; RAT) pair comprises one PLMN entry paired with one or more associated RAT entries, e.g. N G-RAN, E-UTRAN (WB-S1 mode), E-UTRAN (NB-S1 mode), UTRAN, GERAN and/or GERAN EC-GSM-IoT.

When the cellular communication device processes a particular (PLMN; RAT) pair, the cellular communication device compares the PLMN and RAT(s) with PLMN and associated RATs that it receives through a scan of system information broadcast, SIB, signals from available PLMNs. If there is a match between the (PLMN; RAT) pair and information in one of the received SIB signals, the cellular communication device performs a registration with that PLMN. If there is no match, the cellular communication device continues to process the subsequent (PLMN, RAT) pair in the PLMN selector list. The cellular communication device may also store a so-called Forbidden list, storing PLMNs that are forbidden, at least temporarily, for the cellular communication device to attempt a registration. The communication devices stores PLMNs in this list for which registration attempts have failed recently in order to avoid that the communication device keeps trying to register with these PLMNs.

### SUMMARY

The applicants have recognized that the PLMN selector list works satisfactorily where selection of a particular PLMN is more important than selection of a particular RAT. However, there may be cases wherein selection of at least one RAT is less or more preferred than other RATs for the same PLMN. One example includes satellite access. Satellite access may be provided by specific PLMNs, but it is also possible that an operator of an existing PLMN exploiting terrestrial networks for wireless access adds satellite access with the same PLMN code as a RAT.

Because of the different nature of satellite access (e.g. in price, throughput, latency), a user and/or operator may e.g. want to indicate that any PLMN with a terrestrial access technology is better than a PLMN with a non-terrestrial access technology. Non-terrestrial network access, such as geostationary satellite access, low earth orbit satellite access, or high altitude platform access, may then be used as a last resort only, when there are no terrestrial networks available for any PLMN. In order to indicate such a preference, the PLMN selector list would have to list all possible PLMNs with all the non-satellite access technologies before it lists the PLMNs with satellite access technologies. Oppositely, a user may prefer satellite access over access via any terrestrial network in which case a similarly long PLMN selector list needs to be provided in the cellular communication device which lists all possible PLMNs with satellite access technology before listing PLMNs with non-satellite access technologies. This results in inefficient PLMN selector lists consuming too much memory space and/or transmission capacity when PLMN selector lists are provisioned over the air.

One aspect of the disclosure involves a cellular communication device performing PLMN selection using a (PLMN; RAT) pair of a PLMN selector list, wherein the PLMN selector list is configured to indicate that the PLMN entry of the pair indicates any PLMN, instead of a single PLMN as in the prior art, may be selected for any RAT indicated by the RAT entries in the pair.

One aspect of the disclosure pertains to a cellular communication device configured for performing a Public Land Mobile Network, PLMN, selection procedure to attempt registration with a PLMN. The selection procedure may involve accessing a PLMN selector list. The PLMN selector list may be stored on a memory card (e.g. a SIM card) or otherwise in a security module (e.g. an eSIM) or in a memory part of the cellular communication device.

The PLMN selector list may comprise at least one pair of a PLMN entry and at least one Radio Access Technology, RAT, entry, each RAT entry indicating one RAT. The pair may be referred to as a (PLMN; RAT) pair. In one embodiment, the PLMN entry of the (PLMN; RAT) pair may be associated with a value. The value may be a value of the PLMN entry itself or another value or indicator in the PLMN selector list. The value may be set to indicate that two or more PLMNs for at least one RAT of the (PLMN; RAT) pair may be selected, such as, for example, any PLMN. The cellular communication device may be configured to sequentially select the two or more PLMNs when processing the (PLMN; RAT) pair in the PLMN selector list to attempt registration with the selected PLMN.

The PLMN selector list may be stored in a security module for the cellular communication device or in the cellular communication device itself. Accessing the PLMN selector list by the cellular communication device involves accessing the security module for the cellular communication device via an electronic interface between the cellular communication device (e.g. processing circuitry thereof) and the security module for the cellular communication device.

In particular, when processing the (PLMN; RAT) pair, the cellular communication device obtains the PLMN entry of the pair and is configured to interpret the set value associated with the PLMN entry as that two or more PLMNs, for example any PLMN, may be selected for attempting a registration. The cellular communication device may then sequentially attempt registration with the two or more PLMNs until registration is successful.

The cellular communication device may select any PLMN allowed by the PLMN entry in the (PLMN; RAT) pair, before proceeding to a next (PLMN; RAT) pair in the PLMN selector list. Whereas the cellular communication device selects one PLMN at the time when processing the (PLMN; RAT) pair, it should be appreciated that, in one embodiment, sequential selection is applied since it may occur that registration attempts with PLMNs allowed by the PLMN entry fail. Especially when the value associated with the PLMN entry is set to “any PLMN”, there is a greater chance of a failed attempt. Reasons for such failed attempts may include the absence of a roaming agreement between the home PLMN of the cellular communication device and the selected PLMN when processing the (PLMN; RAT) pair.

Yet another aspect of the disclosure pertains to a security module for a cellular communication device. The security module may store or may be configured to store a Public Land Mobile Network, PLMN, selector list comprising at least one pair of a PLMN entry and at least one Radio Access Technology, RAT, entry, each RAT entry indicating one RAT. The PLMN entry of the (PLMN; RAT) pair may be associated with a value standardized to indicate two or more PLMNs may be selected, by the cellular communication device for the at least one RAT entry when processing the (PLMN; RAT) pair.

Still another aspect of the disclosure pertains to an electronic data structure comprising a Public Land Mobile Network, PLMN, selector list for use with a cellular communication device. The list comprises at least one pair of a PLMN entry and at least one Radio Access Technology, RAT, entry, each RAT entry indicating one RAT. The PLMN entry of the (PLMN; RAT) pair may be associated with a value standardized to indicate two or more PLMNs may be selected, by the cellular communication device for the at least one RAT entry when processing the (PLMN; RAT) pair.

Yet another aspect of disclosure pertains to a telecommunications network, or system therein, storing such an electronic data structure for transmission to a cellular communication device and to a method for transmitting such an electronic data structure to a cellular communication device.

A further aspect of the disclosure pertains to a PLMN selection method in a cellular communication device to attempt registration by accessing a PLMN selector list comprising at least one pair of a PLMN entry and at least one Radio Access Technology, RAT, entry, each RAT entry indicating one RAT. The pair may be referred to as a (PLMN; RAT) pair. The method involves sequentially selecting two or more PLMNs when processing a (PLMN; RAT) pair in the PLMN selector list to attempt registration with the selected PLMN. In one embodiment, the PLMN entry of the (PLMN; RAT) pair may be associated with a value. The value may be a value of the PLMN entry itself or another value or indicator in the PLMN selector list. The value may be set to indicate that two or more PLMNs for at least one RAT of the (PLMN; RAT) pair that may be selected, such as, for example, any PLMN, when processing the (PLMN; RAT) pair.

The inventive PLMN selector list compresses the size of the list by enabling the single PLMN entry of a single (PLMN; RAT) pair to be associated with multiple PLMNs, so that storage space may be saved and/or wireless transmission capacity may be saved. Moreover, the PLMN selector list may be organized more efficiently when a particular RAT is preferred or particular RATs are preferred irrespective of the PLMN to which the registration should be made to use that RAT. In one embodiment, the value associated with the PLMN entry is standardized to refer to any PLMN. In this manner, for example, only a single (PLMN; RAT) pair needs to be provided on the PLMN selector list to indicate that one access technology is preferred over another access technology. The pair may be (*; RAT1, RAT2, RAT3)) to indicate that the cellular communication device should select any available PLMN (the asterisk * for the PLMN entry indicates a wildcard for a PLMN to be selected) that offers RAT1, RAT2 and/or RAT3 when processing the (PLMN; RAT) pair provided that the cellular communication device supports RAT1, RAT2 and/or RAT3.

It should be appreciated that there are many implementations for the PLMN entry in the (PLMN; RAT) pair that indicate that more than one PLMN may be selected for the particular RAT or RATs, whereas in the prior art, the PLMN selector list always associates a single PLMN with the PLMN entry of the pair. Specific values may be standardized as specific values for (elements of) the PLMN entry. Examples include a wildcard, a specific standardized code, etc. Alternatively, the PLMN selector list may also comprise specific indications external to the PLMN entry itself that indicate that a value of a PLMN entry indicates that more than one PLMN may be selected for a PLMN entry of a (PLMN; RAT) pair. The disclosed PLMN entry allows for easy implementation within existing telecommunications standards.

A PLMN entry in the prior art comprises a Mobile Country Code, MCC, and a Mobile Network Code, MNC, such that the network of an operator within a particular area or country can be identified in a globally unique manner. A part of the PLMN entry may be set with the value indicating that more PLMNs may be selected in the PLMN selection procedure when processing a (PLMN; RAT) pair. For example, the PLMN entry for the (PLMN; RAT) pair disclosed herein may have a value for at least the MNC part that is associated with a value set to indicate that “any MNC” may be selected in the PLMN selection procedure. The cellular communication device may be configured to sequentially select a PLMN with any MNC when processing the (PLMN; RAT) pair in the PLMN selector list. With the selection of any MNC within the MCC domain, the cellular communication device may select the PLMN of various operators within the area indicated by the MCC when processing the (PLMN; RAT) pair. In one embodiment, the (PLMN; RAT) pair may be stored as (MCC*; RAT1, RAT2) instructing the cellular communication terminal to select a PLMN with an arbitrary MNC, provided that the UE supports RAT1 and RAT2 and the cellular communication device is in the MCC domain.

It should be appreciated that the Mobile Country Code, MCC, may be wildcarded alternatively or additionally to the MNC, with the MNC set to a specific value or with the MNC also wildcarded. Such an embodiment may be of use, for example, when the cellular communication device is near the border of the MCC domain.

Another embodiment involves a security module wherein the standardized value may comprise at least a value for a Mobile Network Code, MNC, wherein the standardized value may indicate that any MNC may be selected. Yet another embodiment involves an electronic data structure comprising a PLMN selector list with at least one PLMN entry comprising such an MNC entry.

In one embodiment, the cellular communication device may be configured to receive a signal from a PLMN indicating a PLMN value of the PLMN. The signal may comprise a system information broadcast, SIB, message, for example a SIB1 message, containing the PLMN value (e.g. a PLMN ID) associated with the PLMN that sends the signal. When the cellular communication device processes the (PLMN; RAT) pair and has received the PLMN value from the signal, the cellular communication device may select the PLMN fora registration attempt irrespective of the PLMN value in the signal. The cellular communication device ignores the PLMN value of the signal by virtue of the value associated with the specific PLMN entry in the PLMN selector list indicating that the PLMN value in the signal is irrelevant.

In one embodiment, the cellular communication device may be configured to attempt registration with the PLMN using a RAT indicated in the at least one RAT entry of the (PLMN; RAT) pair supported by the cellular communication device. As mentioned above, the registration request may be made to any PLMN that offers the RAT that is supported by the cellular communication device by virtue of the value associated with the specific PLMN entry.

In one embodiment, the cellular communication device may be configured to receive signals, for example system information broadcasts, SIBs, from two or more PLMNs. Each signal, for example, each SIB, may comprise a PLMN value (e.g. a PLMN ID) associated with the respective PLMN. The cellular communication device may be configured to select a PLMN as a first PLMN from the two or more PLMNs based on a condition.

The embodiment facilitates a registration attempt by selecting one PLMN as a first PLMN from the available PLMNs allowed by the (value associated with the) PLMN entry of the (PLMN; RAT) pair by applying a condition.

In one embodiment, the condition may comprise a signal strength condition. The PLMN selected first by the cellular communication device from the available PLMNs allowed by the value set for the PLMN entry may be selected on the basis of the signal strength from the PLMNs. One criterion to this end involves evaluating signal strength of one or more PLMNs and comparing these with a signal strength threshold. Another criterion comprises comparing signal strengths from a plurality of PLMNs with each other and select one of the PLMNs on the basis of the comparison, for example selecting the PLMN with the highest signal strength as the first PLMN.

In one embodiment, the condition comprises a time condition. The PLMN selected first by the cellular communication device may, as an example, select the PLMN for which the signal was received first. Another example involves the cellular communication device maintaining a timer window selecting a PLMN for which a suitable signal strength, e.g. a signal strength meeting a set threshold, was received within the time window.

In one embodiment, the condition comprises an available services condition. The PLMN selected first by the cellular communication device may, as an example, select the PLMN on which particular services are provided. Alternatively, PLMN entries may be skipped in case particular services are not available via that PLMN. Information regarding available services may, in one embodiment, be received from the PLMN in signalling, e.g. via the SIB messages.

Yet another condition for selecting a first PLMN is a random condition, wherein an arbitrary PLMN is selected from the two or more PLMNs when processing the (PLMN; RAT) pair.

The cellular communication device may also apply any combination of the above conditions for selecting a first PLMN and possibly, subsequent PLMNs if the registration attempt with the first PLMN fails.

In one embodiment, the PLMN selector list may comprise at least one further (PLMN; RAT) pair. The further PLMN entry of the further (PLMN; RAT) pair comprises a value set to indicate one specific PLMN as in the prior art. The cellular communication device and/or the PLMN selector list are configured such that the cellular communication device processes the (PLMN; RAT) pair before the further (PLMN; RAT) pair.

In one embodiment, the PLMN selector list comprises at least one further (PLMN; RAT) pair, wherein a further PLMN entry of the further (PLMN; RAT) pair comprises a value set to indicate one specific PLMN, wherein at least one of the following applies:
at least one RAT entry of the (PLMN; RAT) pair is different from any RAT entry of the further (PLMN; RAT) pair;
at least one RAT entry of the further (PLMN;RAT) pair is different from any RAT entry of the (PLMN; RAT) pair;
no RAT entry of the (PLMN; RAT) pair specifies non-terrestrial access, whereas at least one RAT entry of the further (PLMN; RAT) pair specifies non-terrestrial access;
at least one RAT entry of the (PLMN; RAT) pair specifies non-terrestrial RAT access.

This embodiment allows the user and/or operator to prioritize access technologies while using a PLMN selector list. The (PLMN; RAT) pair may be processed before the further (PLMN; RAT) pair or vice versa.

In one embodiment, the (PLMN; RAT) pair may be defined as (*; RAT1) and the further (PLMN; RAT) pair may be defined as (PLMN1; RAT2), wherein PLMN1 points to one specific PLMN. In this embodiment, the PLMN selector list may be organized to indicate that one RAT, RAT1, is always preferred over another RAT, irrespective of the PLMN offering RAT1.

In one embodiment, the (PLMN; RAT) pair may be defined as (*; RAT1, RAT2, RAT3) and the further (PLMN; RAT) pair is defined as (PLMN1; SAT), wherein RAT1, RAT2 and RAT3 may be any RAT except satellite access SAT, PLMN1 is a value pointing to one specific PLMN and SAT1 indicates satellite access or any specific form of satellite access. When the (PLMN; RAT) pair is processed before the further (PLMN; RAT) pair, satellite access from PLMN1 is only used as a last resort access technology, i.e. when RAT1, RAT2 and RAT3 are not available from any PLMN.

In another embodiment, the (PLMN; RAT) pair is defined as (*; SAT1, SAT2) and the further (PLMN; RAT) pair is defined as (PLMN1; RAT1, RAT2, RAT3), wherein, again RAT1, RAT2 and RAT3 may be any RAT except satellite access, PLMN1 is a value pointing to one specific PLMN and SAT1 and SAT2 indicate satellite access technologies. In this manner, the cellular communication device may prioritize satellite access. It should be appreciated that the PLMN selector list may contain more (PLMN; RAT) pairs that precede and/or follow the disclosed (PLMN; RAT) pair with the PLMN entry indicating more than one PLMN to be selected when processing this (PLMN; RAT) pair.

Other aspects include embodiments of a security module storing or configured to store the (PLMN; RAT) pair and at least one further (PLMN; RAT) pair as mentioned above. Yet another embodiment involves an electronic data structure comprising a PLMN selector list with these pairs.

In one embodiment, the cellular communication device may further be configured to access a black list comprising one or more PLMNs that should not be selected when the set value in the PLMN selector list for the (PLMN; RAT) pair indicates that two or more PLMNs can be selected. The cellular communication device may be configured to refrain from selecting the one or more PLMNs appearing on the black list although the (PLMN; RAT) pair with the wildcarded PLMN entry would allow for the selection of the PLMN. In this manner, the user and/or operator is enabled to provide restrictions to the PLMNs selectable according to the PLMN entry of the pair, e.g. by excluding PLMNs with which the HPLMN does not have a roaming agreement. The black list may, for example, avoid the cellular communication device to have to attempt registration with PLMNs for which it is certain that a rejection will follow.

In one embodiment the cellular communication device may be configured to receive the black list over-the-air (OTA) from a home PLMN.

In one embodiment, the cellular communication device may be configured to receive at least one of the PLMN selector list and the black list over-the-air (OTA) from a home PLMN. OTA-transmission of the PLMN selector list comprising the disclosed (PLMN; RAT) pair requires fewer transmission resources. The black list enable the operator to disable certain PLMNs for a registration attempt when processing the PLMN selector list.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 is a schematic illustration of a telecommunications network comprising a cellular communication device storing a PLMN selector list according to the prior art;

FIG. 2 is a schematic illustration of a telecommunications network comprising a cellular communication device storing a PLMN selector list according to an embodiment of the invention;

FIGS. 3A-3D are schematic illustrations of PLMN selector lists according to embodiments of the invention;

FIG. 4 is a schematic illustration of a cellular communication device according to an embodiment of the invention;

FIG. 5 is a flow chart comprising steps for which a cellular communication device according to an embodiment of the invention is configured; and

FIG. 6 depicts a processing system according to an embodiment for a cellular communication device or a system in a telecommunications network.

### DETAILED DESCRIPTION OF THE DRAWINGS

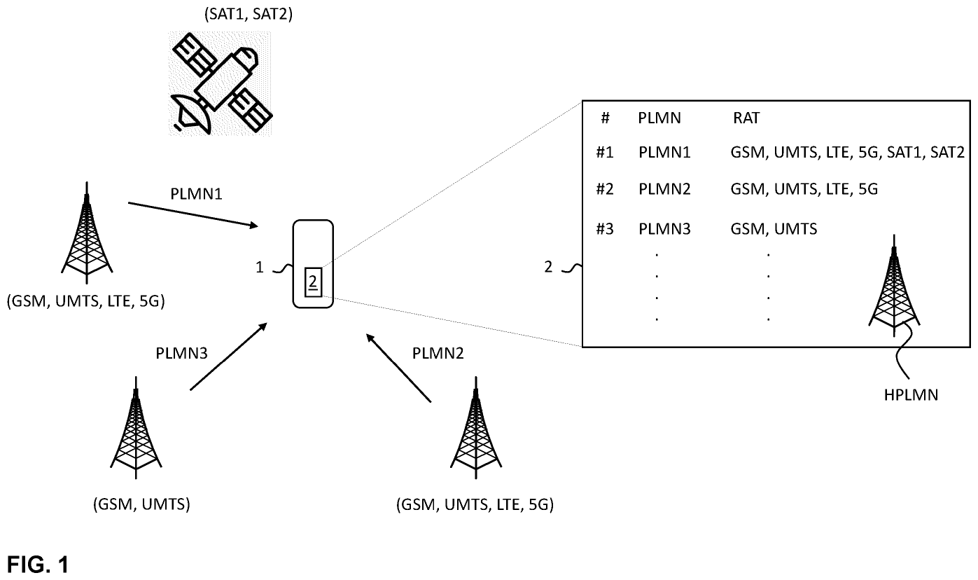

FIG. 1 is a schematic illustration of a telecommunications network comprising a plurality of public land mobile networks, PLMNs and a cellular communication device 1 configured for attempting registration with a PLMN using a network selection procedure. Network selection may be initiated at switch on of a device or when a device enters a network from an area without coverage. PLMN reselection may also be performed when a timer expires to see whether another PLMN is available that is more preferable than the one the device is currently registered with.

The cellular communication device 1 may be a User Equipment, UE, as defined by 3GPP and may be a mobile communication device. A UE can take any form, including smart phones, laptops, static or mobile devices used for machine-to-machine (M2M) or Internet-of-Things (IoT) applications. The latter devices may use specific timers for network selection.

In FIG. 1, the cellular communication device 1 is in an area where no coverage from the home network HPLMN or Equivalent HPLMN (EHPLMN) is available. The cellular communication device 1 has a subscription with the HPLMN. The area for the cellular communication device 1 in FIG. 1 shows coverage from a plurality of other PLMNs, viz. PLMN1, PLMN2 and PLMN3.

PLMN1 is associated with an operator offering access via various RATs, viz. terrestrial access networks using GSM, UMTS, LTE, 5G and non-terrestrial access networks, indicated as SAT1, SAT2. Non-terrestrial network access SAT1, SAT2, may include geostationary satellite access, low earth orbit satellite access, or high altitude platform access. It is assumed that the cellular communication device 1 supports all these access technologies.

PLMN2 is associated with an operator offering access via various terrestrial access networks, viz. GSM, UMTS, LTE and 5G. PLMN3 is associated with an operator offering terrestrial access only via GSM and UMTS. PLMN2 and PLMN3 offer no non-terrestrial access.

The cellular communication device 1 contains a PLMN selector list 2, i.e. an electronic data structure that can be used by the cellular communication device 1 for registration with a PLMN. The PLMN selector list 2 is shown in enlarged fashion on the right-hand side of FIG. 1.

The PLMN selector list 2 is used by the cellular communication device 1 to attempt registration with PLMNs defined in that list. The PLMN selector list may be a user defined list and/or an operator defined list. An operator-defined list is stored in the telecommunications network HPLMN as schematically indicated in FIG. 1. The PLMN selector list 2 may be received by the cellular communication device 1 from the HPLMN where the cellular communication device 1 has a subscription with over the air (OTA) or may be preconfigured on a memory card or security module, such as a SIM card or eSIM.

The PLMN selector list 2 comprises a plurality of pairs of PLMNs and radio access technologies, RATs. In the prior art, the PLMN selector list 2 comprises (PLMN; RAT) pairs each having a single PLMN entry (PLMN1, PLMN2 or PLMN3) paired with one or more RAT entries. The PLMN entries in the PLMN selector list 2 may be organized in priority order, e.g. by an explicit priority organization, indicated by #before a (PLMN; RAT) pair, indicating that the (PLMN; RAT) pair #1 should be processed by the cellular communication device 1 before pair #2 and pair #3. The PLMN selector list 2 may be stored on a memory card (e.g. a SIM card) or otherwise in a security module (e.g. an eSIM) or in a memory part of the cellular communication device 1.

The PLMN selector list 2 in FIG. 1 shows that for PLMN1, the cellular communication device 1 may use several RATs, indicated by RAT entries GSM, UMTS, LTE, 5G, SAT1 and SAT2. Likewise, for PLMN2, the cellular communication device 1 may use GSM, UMTS, LTE and 5G for PLMN2 and GSM and UMTS for PLMN3 in accordance with the PLMN selector list 2. The PLMN selector list 2 may contain more (PLMN, RAT) pairs.

The cellular communication device 1 is made aware of the existence of the different PLMNs in its area of presence by RAT-specific signals emitted from the base stations of the various PLMNs, indicated by the arrows in FIG. 1, for particular RAT(s). Satellites may also emit such signals, e.g. when integrated with a 5G terrestrial network. The signals are typically broadcast from base stations of the PLMN operator, for example as System Information Blocks, SIB. The signals comprise a PLMN identifier. The PLMN identifier may comprise a Mobile Country Code, MCC and a Mobile Network Code, MNC, forming an MCC/MNC tuple. The MCC may, for example, identify the area where the network is located and the MNC identifies the operator of the network in that area.

When the cellular communication device 1 processes a particular (PLMN; RAT) pair in a PLMN selector list 2 (user-defined or operator-defined), the cellular communication device 1 compares values of a PLMN entry and associated RAT entries with PLMN and associated RATs that it receives through a scan of the SIB signals from available PLMNs in the area. If there is a match between the values of a (PLMN; RAT) pair and one of the received SIB signals and RAT via which the SIB signal is received, the cellular communication device 1 attempts a registration with that PLMN. If there is no match, the cellular communication device 1 continues to process the subsequent (PLMN, RAT) pair in the PLMN selector list, possibly in accordance with the priority order of the (PLMN; RAT) pairs. When there are no further (PLMN, RAT) pairs in the PLMN selector list and the cellular communication device 1 has not found a match, the cellular communication device 1 may select one of the available PLMNs based on for example a signal strength condition.

When the cellular communication device 1 processes the PLMN selector list 2 of FIG. 1, the PLMN selector list 2 may force the cellular communication device 1 to use SAT1 or SAT2 as a RAT when attempting registration with PLMN1. This may be undesired because of, for example, costs of satellite access. Only when none of the RAT entries for (PLMN; RAT) pair #1 are available in PLMN1 for the cellular communication device 1, the cellular communication device 1 will process the subsequent, further (PLMN; RAT) pair #2. When a user or operator wants to avoid selection of satellite access by the cellular communication device 1, another (PLMN; RAT) pair should be defined in the list 2, e.g. (PLMN1; SAT1, SAT2), with a (much) lower priority. Other preferences for access technologies, e.g. LTE always from any available PLMN, need similar organization which is complex and expands the PLMN selection list 2. Expanded PLMN lists are disadvantageous for storage capacity and transmission capacity alike.

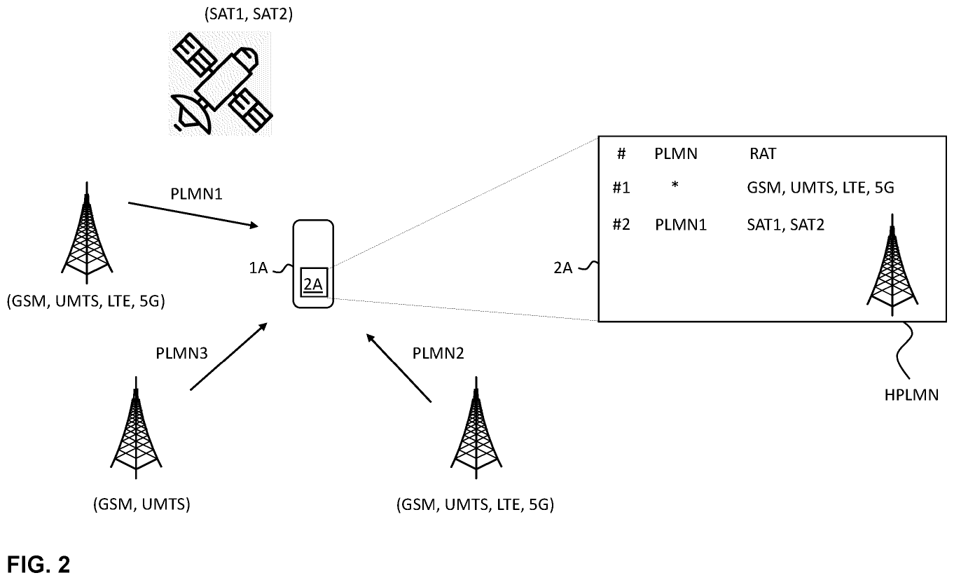

FIG. 2 is a schematic illustration of a telecommunications network comprising a cellular communication device 1A storing a PLMN selector list 2A. The telecommunications network, cellular communication device and PLMN selector list are similar to the ones described with reference to FIG. 1 except for the following. In particular, the adaptations for the cellular communication device 1A and the PLMN selector list 2A are limited so that these can be easily fit into existing telecommunications standards.

In the present application, values are disclosed associated with the PLMN entry of the PLMN selector list that indicate that two or more PLMNs may be selected for a (PLMN; RAT) pair instead of only a single PLMN as described for FIG. 1. The cellular communication device 1A is configured to sequentially select the two or more PLMNs when processing the (PLMN; RAT) pair in the PLMN selector list 2A to attempt registration with the selected PLMN. In particular, when processing the (PLMN; RAT) pair, the cellular communication device 1A obtains the PLMN entry of the pair (for example from a memory card or secure module) and is configured to interpret the set value associated with the PLMN entry as that two or more PLMNs, for example any PLMN, may be selected for attempting a registration.

The PLMN selector list 2A compresses the size of the list by enabling the single PLMN entry of a single (PLMN; RAT) pair to be associated with multiple PLMNs, so that storage space may be saved on a memory card or in a security module and/or wireless transmission capacity may be saved when the PLMN selector list 2A is provided over-the-air (OTA). Moreover, the PLMN selector list 2A can be organized efficiently when a particular RAT is preferred or particular RATs are preferred irrespective of the PLMN to which the registration should be made to use that RAT.

In FIG. 2, the PLMN selector list comprises a (PLMN; RAT) pair indicated as #1 and a further (PLMN; RAT) pair indicated by #2. As in FIG. 1, #1 and #2 indicate a priority order. It should be appreciated, however, that priority may be indicated in other manners or be implicit.

The (PLMN; RAT) pair #1 comprises a set value for the PLMN entry indicated as * (a common symbol for a wildcard) indicating that any PLMN may be selected that has the associated RATs in the pair. When the cellular communication device 1A processes the (PLMN; RAT) pair, it interprets the value * as that it is free to select any available PLMN when processing that pair. In one embodiment, the set value may be a standardized value that is interpreted by the cellular communication device 1A to indicate that it should select any available PLMN.

It should be appreciated that there are many implementations for the PLMN entry in the (PLMN; RAT) pair that indicate that more than one PLMN may be selected for the particular RAT or RATs, in contrast with the prior art, as shown in FIG. 1, wherein the PLMN selector list always associates a single PLMN with the PLMN entry of the pair. Alternatively, the PLMN selector list may also comprise specific indications external to the PLMN entry itself (for example, a separate list or an additional column in the PLMN selector list indicating how the PLMN entry should be interpreted, such as a specific wildcard column with a yes/no indication for one or more (PLMN; RAT) pairs) that indicate that more than one PLMN may be selected for a PLMN entry of a (PLMN; RAT) pair. The disclosed PLMN entry allows for easy implementation within existing telecommunications standards.

When processing the (PLMN; RAT) pair #1, the cellular communication device 1A obtains the pair and interprets the wildcard * as that it should select any PLMN that offers any of the terrestrial RATs indicated in the pair. Hence, in one embodiment, the cellular communication device 1A may again first select PLMN1 but will only register using terrestrial access technologies as a result of the RATs in pair #1. Although PLMN #1 offers access via non-terrestrial networks SAT1, SAT2, the cellular communication device 1A, will only select PLMN #1 where PLMN #1 provides any of the terrestrial RATs. The cellular communication device 1A may also select PLMN2 or PLMN3 to attempt registration using terrestrial access technologies. Only when there are no PLMNs available that offer terrestrial access in the area of the cellular communication device 1A or when all PLMNs available have been selected to attempt registration with terrestrial access technologies and these have failed, the cellular communication device 1A will move to the further (PLMN; RAT) pair #2 and again select PLMN1 to request registration for non-terrestrial access via SAT1 or SAT2 for the case in FIG. 2.

As mentioned above, PLMN selector list 2A may have been organized with a priority order for the (PLMN; RAT) pairs. However, when a PLMN entry in such a pair indicates that two or more PLMNs may be selected when processing the pair, it should be decided which PLMN should be selected first when processing the pair. In the above example of FIG. 2, there is no specific reason why registration with PLMN1 was attempted first. It may be that PLMN1 was selected arbitrarily in a random fashion.

The applicants have considered more intelligent criteria wherein a PLMN is selected as a first PLMN from the available PLMNs allowed by the (value associated with the) PLMN entry of the (PLMN; RAT) pair by applying a condition. The condition or the plurality of conditions may determine which of the PLMNs is selected first, second, third, etc. when processing the (PLMN; RAT) pair.

In one embodiment, the condition may comprise a signal strength condition. The PLMN selected first by the cellular communication device 1A from the available PLMNs that have been detected may be selected on the basis of the signal strength from the PLMNs, e.g. by measuring the signal strength of the signal that contains the PLMN ID. In FIG. 2, one approach to this end involves evaluating signal strengths of PLMN1, PLMN2 and PLMN3 comparing these with a signal strength threshold. In the above example, it may turn out that only the signal strength of PLMN1 exceeds the threshold. Another approach comprises comparing signal strengths from PLMN1, PLMN2 and PLMN3 and select the PLMN on the basis of the comparison. For example, PLMN1 may have been selected as a first PLMN to attempt registration because the signal from PLMN1 has the highest signal strength.

In one embodiment, the condition comprises a time condition. In the above example, PLMN1 may have been selected as a first PLMN by the cellular communication device 1A when processing the (PLMN; RAT) pair, because the SIB with the PLMN ID was received first from PLMN1. It should be appreciated in this respect that the PLMN IDs are broadcast periodically so that time differences may occur. Another example involves the cellular communication device maintaining a timer window selecting a PLMN for which a suitable signal strength was received within the time window. In this example, two conditions have been combined to select a PLMN. In FIG. 2, the cellular communication device 1A may receive signals from PLMN1 and PLMN2 with signal strengths above a threshold, but the signal from PLMN2 was received outside the time window, so that PLMN1 was selected as the first PLMN to attempt registration with. The time window may be a sliding time window, so that, if registration with PLMN1 fails for the terrestrial access networks, PLMN2 may be subsequently selected when processing the (PLMN; RAT) pair.

In one embodiment, the condition comprises an available services condition, e.g. a VoIMS support indication. The PLMN selected first by the cellular communication device may, as an example, select the PLMN on which particular services are provided. Alternatively, PLMN entries may be skipped in case particular services are not available via that PLMN.

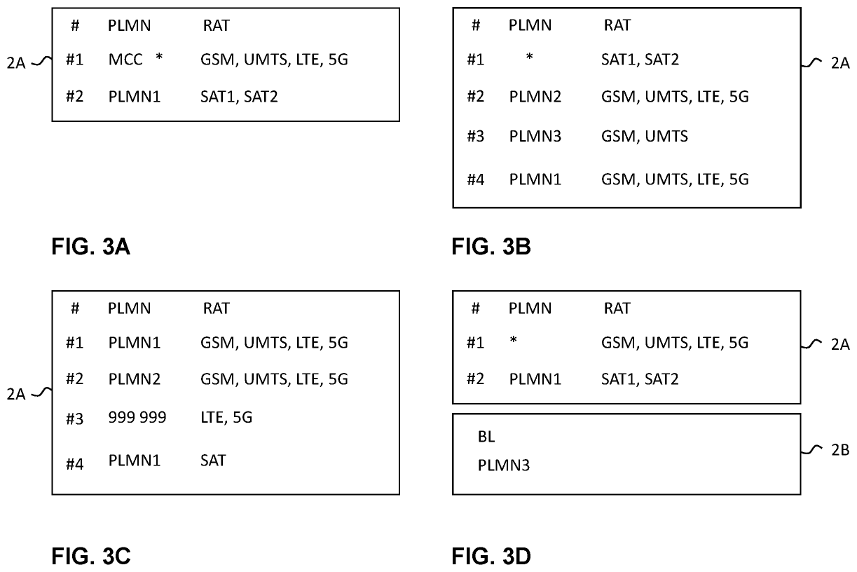

FIGS. 3A-3D show electronic data structures representing PLMN selector list 2A comprising a value set in the list for a PLMN entry to indicate that two or more PLMNs may be selected when processing a particular (PLMN; RAT) pair.

In FIG. 3A, a PLMN entry is shown as a combination of a Mobile Country Code, MCC, and a Mobile Network Code, MNC. The MNC part of the PLMN entry is set with the value indicating that more PLMNs may be selected in the PLMN selection procedure when processing a (PLMN; RAT) pair. The PLMN entry for the (PLMN; RAT) pair shown has a value for the MNC that is associated with a value set to indicate that “any MNC” may be selected in the PLMN selection procedure using a wildcard value. The cellular communication device 1A may be configured to sequentially select a PLMN with any MNC when processing the (PLMN; RAT) pair in the PLMN selector list 2A. With the selection of any MNC within the MCC domain, the cellular communication device 1A interprets the wildcard for the MNC so that it may select the PLMN of various operators within the area indicated by the MCC when processing the (PLMN; RAT) pair. Again, in selecting the MNC, i.e. the operator in the area, the cellular communication device 1A may apply a condition as described above. In the embodiment of FIG. 3A, like in FIG. 2, the PLMN selector list 2A indicates that any PLMN that offers terrestrial access is preferred above PLMN1 offering satellite access.

In FIG. 3B, on the other hand, the PLMN selector list 2A is configured such that the cellular communication device 1A has a preference for satellite access. This may, for example, be beneficial for communication devices that travel frequently over large distances and require periodic or continuous access, also in areas with limited or no terrestrial network coverage, e.g. devices on boards of vessels or aircraft. In the case of FIG. 2, a cellular communication device 1A with the PLMN selector list 2A of FIG. 3B provided over-the air, for example, will first attempt to register with the satellite network technology of SAT1, SAT2 before proceeding to the further (PLMN; RAT) pair with PLMN2 and further.

It is not necessary that the (PLMN; RAT) pair with the specific PLMN entry disclosed herein is on top of the PLMN selector list 2A. In FIG. 3C, the PLMN selector list 2A, comprises two regular (PLMN; RAT) pairs wherein the cellular communication device 1A makes a registration attempt with PLMN1 and subsequently PLMN2, if PLMN1 is not available or fails, for the indicated RATs. For (PLMN; RAT) pair #3, the PLMN entry is set to a value “999 999” that is interpreted by the cellular communication device 1A as that it may select two or more PLMNs with the associated RATs when processing (PLMN; RAT) pair #3. If the cellular communication device 1A in FIG. 2 processes this pair with the PLMN selector list 2A of FIG. 3C, it is likely that processing this pair would not result in the selection of a PLMN. PLMN1 and PLMN2 were already unsuccessful for LTE and 5G when processing pairs #1 and #2 and PLMN3 does not offer LTE or 5G in the area of cellular communication device 1A as required by the RAT entries for pair #3. Accordingly, the cellular communication device 1A would process (PLMN; RAT) pair #4 and select PLMN1 with satellite access as a last resort. It is noted that if (PLMN; RAT) pair #3 would include a RAT entry for UMTS, the cellular communication device 1A would have selected PLMN3 offering UMTS access when processing this pair #3.

FIG. 3D depicts a PLMN selector list 2A that is identical to the PLMN selector list shown in FIG. 2. However, in FIG. 3D, the PLMN selector list 2A is shown in combination with a black list 2B. The cellular communication device 1A is configured to access the black list 2B comprising one or more PLMNs that should not be selected when the set value in the PLMN selector list for the (PLMN; RAT) pair indicates that two or more PLMNs can be selected. In FIG. 3D, the cellular communication device 1A is configured to refrain from selecting PLMN3 appearing on the black list 2B although the (PLMN; RAT) pair #1 with the wildcarded PLMN entry would allow for the selection of PLMN3. In this embodiment, the user and/or operator is enabled to provide restrictions to the PLMNs selectable according to the PLMN entry of the pair #1. In one embodiment the cellular communication device 1 may be configured to receive the black list over-the-air (OTA) from the Home PLMN. The operator of the HPLMN may, for example, not have a roaming agreement with PLMN3. It should also be appreciated that the black list 2B is different from the Forbidden list from the prior art that is filled by the communication device itself based on previous registration attempts.

The black list 2B of one or more PLMNs could also come with one or more RATs. The black list may be used only after first using the PLMN selector list. If a selected PLMN (optionally, with access technology) is on the black list, the cellular communication device 1A may search for other PLMNs that fit the current PLMN entry on the PLMN Selector list. If that does not produce a result, the communication device 1A may continue down the list with the next pair.

It should be noted that that multiple wildcarded PLMN IDs may appear on a PLMN selector list 2A, e.g. in combination with different RATs.

The embodiments in FIGS. 3A-3D are all examples, wherein only the processing of the cellular communication device 1A has to be configured such that it can appropriately interpret the special value of a PLMN entry as to sequentially select two or more PLMNs when processing the (PLMN; RAT) pair with the specific value. The PLMN selector list 2A itself, may also be configured or structured differently for this purpose, e.g. by adding a separate information element that indicates that a PLMN entry indicates that the PLMN entry of a single (PLMN; RAT) pair should be interpreted to indicate two or more PLMNs may be selected sequentially.

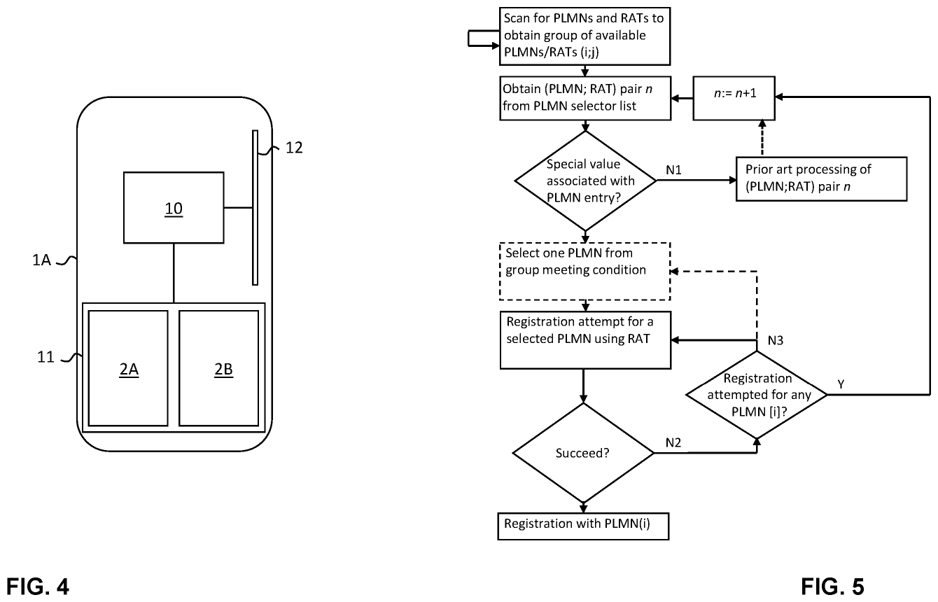

FIGS. 4 and 5 are a schematic illustration of some components of a cellular communication device 1A and a flow chart illustrating some steps of a PLMN selection procedure in such a device, respectively.

The cellular communication device 1A comprises a processing system 10 and a storage 11 (e.g. a SIM card or eSIM) as well as a communication circuitry 12 for communicating with PLMNs using various RATs. The storage 11 may store at least one of a PLMN selector list 2A and a black list 2B as disclosed herein. One or both of these lists may be received by the communication circuitry 12 from the HPLMN over the air. One or both of these lists may contain a user-defined list.

In general, when starting PLMN selection, the cellular communication device 1A starts from the top of the PLMN selector list when the (E)HPLMN cannot be found. If the cellular communication device 1A can find the PLMN in the first entry and that PLMN provides one of the listed access technologies, then it selects that PLMN. If the PLMN is not found (or not with any of the listed access technologies, then the cellular communication device 1A tries the next pair on the PLMN selector list). When the cellular communication device 1A reaches a pair with a wildcarded PLMN ID (either the PLMN ID is a specific PLMN ID that is considered a wildcard (see FIGS. 3A-3D, for example) or the entry indicates in some other way that the PLMN ID is wildcarded), then the cellular communication device 1A will attempt registration with any available PLMN that provides one of the indicated access technologies. If there is no PLMN that provides the access technologies in the pair with the wildcarded PLMN, then the cellular communication device 1A will continue with the next pair on the PLMN selector list.

More particularly, under reference to FIG. 5, after having searched for the (E)HPLMN which failed, the cellular communication device 1A scans for available PLMNs in its surrounding using RAT-specific signals from the diverse PLMNs, such as SIBs. The scan may be performed continuously or periodically as shown by the arrow pointing back to the scan box in FIG. 5.

In a next step, the cellular communication device 1A obtains a (PLMN;RAT) pair n from the PLMN selector list 2A as indicated in FIG. 5. A pair may be selected according to explicit or implicit priority indications as known in prior art PLMN selector lists. In FIG. 5, the cellular communication device 1A retrieves the pair n from the PLMN selector list 2A and considers the value of the PLMN entry.

In the first diamond box of FIG. 5, it is determined whether the PLMN entry is associated with a special value, indicating that all PLMNs may be selected from the available group of PLMNs using the RAT entry or entries for the pair n.

If the PLMN is not (indicated by N1 in the flow chart) associated with a special value, the (PLMN; RAT) pair n is processed as described with reference to FIG. 1, i.e. attempting registration with the single PLMN indicated by the PLMN entry using one of the RATs indicated in the pair n. If the registration fails, a next pair n+1 is processed. If the registration attempt succeeds, the PLMN selection procedure is stopped (not shown).

If the PLMN is associated with a special value, the cellular communication device 1A may optionally apply a condition to select a first PLMN from the group of available PLMN. The applicants have considered various conditions and combinations thereof, as described above.

Irrespective of whether a condition is applied, the cellular communication device 1A selects one PLMN from the group of available PLMNs and attempts registration with that PLMN. If that registration attempt succeeds, the cellular communication device 1A is registered with the selected PLMN and the PLMN selection procedure stops until registration with the PLMN is lost again (e.g. when the device moves back to its HPLMN which availability is detected during the scan for PLMNs in the top box of FIG. 5).

If the registration attempt fails (N2), the cellular communication device 1A does not immediately obtain the next pair of the PLMN selector list 2A but first considers whether all PLMNs and RATs from the group of available PLMNs and RATs have been tried. The cellular communication device 1A is caused to first try other PLMNs when processing the (PLMN; RAT) pair n by virtue of the special value of the PLMN entry in the pair. As long as not all PLMNs of the group have been tried (N3) with the RATs indicated in the pair n, the cellular communication device 1A will first attempt registration with further PLMNs. The specific sequence wherein the PLMNs are tried may be subject to the condition as well in one embodiment. Only when all PLMNs of the available PLMNs in the group have been tried for registration and failed (Y), the PLMN selection procedure will proceed to the next (PLMN; RAT) pair n+1.

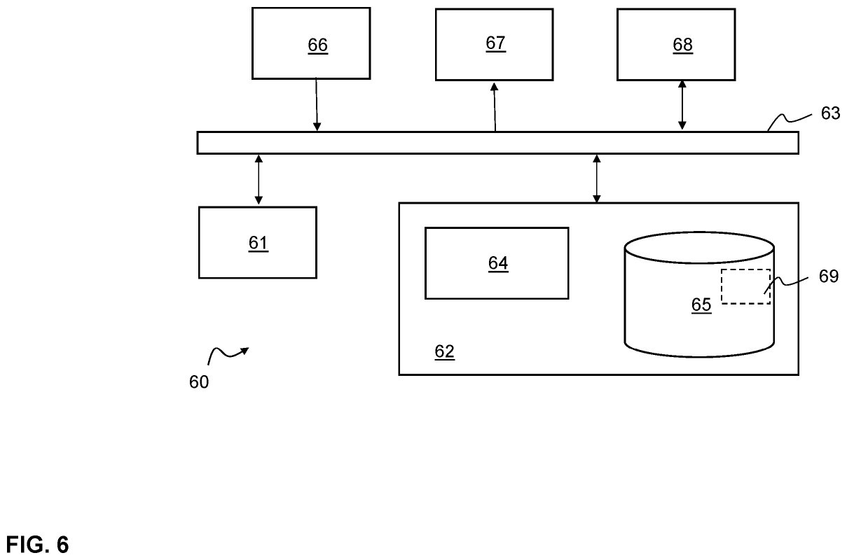

FIG. 6 depicts a block diagram illustrating an exemplary processing system according to a disclosed embodiment, e.g. a UE, as disclosed herein. As shown in FIG. 6, the processing system 60 may include at least one processor 61 coupled to memory elements 62 through a system bus 63. As such, the processing system may store program code within memory elements 62. Further, the processor 61 may execute the program code accessed from the memory elements 62 via a system bus 63. In one aspect, the processing system may be implemented as a computer system that is suitable for storing and/or executing program code. It should be appreciated, however, that the processing system 60 may be implemented in the form of any system including a processor and a memory that is capable of performing the functions described within this specification.

The memory elements 62 may include one or more physical memory devices such as, for example, local memory 64 and one or more bulk storage devices 65. The local memory may refer to random access memory or other non-persistent memory device(s) generally used during actual execution of the program code. A bulk storage device may be implemented as a hard drive or other persistent data storage device. The processing system 60 may also include one or more cache memories (not shown) that provide temporary storage of at least some program code in order to reduce the number of times program code must be retrieved from the bulk storage device 65 during execution.

Input/output (I/O) devices depicted as an input device 66 and an output device 67 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 6 with a dashed line surrounding the input device 66 and the output device 67). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 68 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system and a data transmitter for transmitting data from the processing system 60 to said systems, devices and/or networks. Modems, cable modems, and Ethernet cards are examples of different types of network adapter that may be used with the processing system 60.

As pictured in FIG. 6, the memory elements 62 may store an application 69. In various embodiments, the application 69 may be stored in the local memory 64, the one or more bulk storage devices 65, or apart from the local memory and the bulk storage devices. It should be appreciated that the processing system 60 may further execute an operating system (not shown in FIG. 6) that can facilitate execution of the application 69. The application 69, being implemented in the form of executable program code, can be executed by the processing system 60, e.g., by the processor 61. Responsive to executing the application, the processing system 60 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 61 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A cellular communication device configured for performing a Public Land Mobile Network, PLMN, selection procedure to attempt registration with a PLMN, the selection procedure involving accessing a PLMN selector list, the PLMN selector list comprising at least one pair of a PLMN entry and at least one Radio Access Technology, RAT, entry, each RAT entry indicating one RAT, wherein the PLMN entry of the (PLMN; RAT) pair is associated with a value set to indicate that two or more PLMNs may be selected, wherein the cellular communication device is configured to sequentially select the two or more PLMNs when processing the (PLMN; RAT) pair in the PLMN selector list to attempt registration with the selected PLMN.

2. The cellular communication device according to claim 1, wherein the PLMN entry of the pair comprises a Mobile Country Code, MCC, and a Mobile Network Code, MNC, wherein the value of at least the MNC is associated with a value set to indicate any MNC and the cellular communication device is configured to sequentially select a PLMN with any MNC when processing the (PLMN; RAT) pair in the PLMN selector list.

3. The cellular communication device according to claim 1, wherein the cellular communication device is configured:
to receive a signal, for example a system information broadcast, SIB, from a PLMN indicating a PLMN value of the PLMN; and
to select the PLMN corresponding to the PLMN value in the signal irrespective of the PLMN value indicated in the signal when processing the (PLMN; RAT) pair in the PLMN selector list.

4. The cellular communication device according to claim 1, wherein the cellular communication device is configured to attempt registration with the PLMN using the RAT indicated in the at least one RAT entry of the (PLMN; RAT) pair, provided that the RAT is supported by the cellular communication device.

5. The cellular communication device according to claim 1, wherein the cellular communication device is configured:
to receive signals, for example system information broadcasts, SIB, from two or more PLMNs, each signal comprising a PLMN value associated with the respective PLMN; and
to select a PLMN from the two or more PLMNs when processing the (PLMN; RAT) pair to be selected first based on a condition, wherein, optionally, the condition comprises one or more of:
(a) a signal strength condition, wherein a PLMN is selected first based on the signal strength of the received signal, irrespective of the PLMN value of the PLMN;
(b) a time condition, wherein a first PLMN of the two or more PLMNs is selected first, for example, a PLMN for which a first PLMN value was received successfully before a second PLMN value associated with a second PLMN of the two or more PLMNs, irrespective of the first PLMN value in the signal of the first PLMN and the second value in the signal of the second PLMN; and
(c) an available services condition, wherein a PLMN is selected first based on the available service from the PLMN; and
(d) a random condition, wherein a random PLMN is selected first from the two or more PLMNs; and
(e) a combination of one or more of the conditions a)-d)

6. The cellular communication device according to claim 1, wherein the PLMN selector list comprises at least one further (PLMN; RAT) pair, wherein a further PLMN entry of the further (PLMN; RAT) pair comprises a value set to indicate one specific PLMN and wherein the cellular communication device and the PLMN selector list are configured such that the cellular communication device processes the (PLMN; RAT) pair before the further (PLMN; RAT) pair.

7. The cellular communication device according to claim 1, wherein the PLMN selector list comprises at least one further (PLMN; RAT) pair, wherein a further PLMN entry of the further (PLMN; RAT) pair comprises a value set to indicate one specific PLMN, wherein at least one of the following applies:
at least one RAT entry of the (PLMN; RAT) pair is different from any RAT entry of the further (PLMN; RAT) pair;
at least one RAT entry of the further (PLMN;RAT) pair is different from any RAT entry of the (PLMN; RAT) pair;
no RAT entry of the (PLMN; RAT) pair specifies non-terrestrial access, whereas at least one RAT entry of the further (PLMN; RAT) pair specifies non-terrestrial access;
at least one RAT entry of the (PLMN; RAT) pair specifies non-terrestrial RAT access.

8. The cellular communication device according to claim 1, wherein the cellular communication device is further configured:
to access a black list comprising one or more PLMNs that should not be selected when the set value in the PLMN selector list for the (PLMN; RAT) pair indicates that two or more PLMNs can be selected; and
to refrain from selecting the one or more PLMNs appearing on the black list.

9. The cellular communication device according to claim 1, wherein the cellular communication device is configured to receive at least one of the PLMN selector list and a blacklist comprising one or more PLMNs that should not be selected over-the-air from a home PLMN.

10. A security module for a cellular communication device, the security module being configured to store or storing a Public Land Mobile Network, PLMN, selector list comprising at least one pair of a PLMN entry and at least one Radio Access Technology, RAT, entry, each RAT entry indicating one RAT, wherein the PLMN entry of the (PLMN; RAT) pair is associated with a value standardized to indicate two or more PLMNs are allowed to be selected by the cellular communication device for the at least one RAT entry of the (PLMN; RAT) pair when processing the (PLMN; RAT) pair.

11. The security module according to claim 10, wherein the standardized value comprises at least a value for a Mobile Network Code, MNC, wherein the standardized value indicates any MNC.

12. The security module according to claim 10, wherein the PLMN selector list comprises at least one further (PLMN; RAT) pair, wherein a further PLMN entry of the further (PLMN; RAT) pair comprises a value set to indicate one specific PLMN and wherein the PLMN selector list is configured to indicate priority for the cellular communication device for processing the (PLMN;RAT) pair before the further (PLMN; RAT) pair.

13. The security module according to claim 12 wherein
the PLMN selector list comprises at least one further (PLMN; RAT) pair, wherein a further PLMN entry of the further (PLMN; RAT) pair comprises a value set to indicate one specific PLMN, wherein at least one of the following applies:
at least one RAT entry of the (PLMN; RAT) pair is different from any RAT entry of the further (PLMN; RAT) pair;
at least one RAT entry of the further (PLMN;RAT) pair is different from any RAT entry of the (PLMN; RAT) pair;
no RAT entry of the (PLMN; RAT) pair specifies non-terrestrial access, whereas at least one RAT entry of the further (PLMN; RAT) pair specifies non-terrestrial access;
at least one RAT entry of the (PLMN; RAT) pair specifies non-terrestrial RAT access.

14. An electronic data structure comprising a Public Land Mobile Network, PLMN, selector list for use with a cellular communication device comprising at least one pair of a PLMN entry and at least one Radio Access Technology, RAT, entry, each RAT entry indicating one RAT, wherein the PLMN entry of the (PLMN; RAT) pair is associated with a value standardized to indicate two or more PLMNs for at least one RAT of the pair may be selected for the cellular communication device when processing the (PLMN; RAT) pair.

15. The electronic data structure according to claim 14, for which at least one of the following applies:
the standardized value comprises at least a value for a Mobile Network Code, MNC, wherein the standardized value indicates any MNC;
the PLMN selector list comprises at least one further (PLMN; RAT) pair, wherein a further PLMN entry of the further (PLMN; RAT) pair comprises a value set to indicate one specific PLMN and wherein the PLMN selector list is configured to indicate priority for the cellular communication device the (PLMN; RAT) pair before processing of the further (PLMN; RAT) pair;
the PLMN selector list comprises at least one further (PLMN; RAT) pair, wherein a further PLMN entry of the further (PLMN; RAT) pair comprises a value set to indicate one specific PLMN, wherein at least one of the following applies:
at least one RAT entry of the (PLMN; RAT) pair is different from any RAT entry of the further (PLMN; RAT) pair;
at least one RAT entry of the further (PLMN;RAT) pair is different from any RAT entry of the (PLMN; RAT) pair;
no RAT entry of the (PLMN; RAT) pair specifies non-terrestrial access, whereas at least one RAT entry of the further (PLMN; RAT) pair specifies non-terrestrial access;
at least one RAT entry of the (PLMN; RAT) pair specifies non-terrestrial RAT access.
